(19) United States
(12) Patent Application Publication
(10) Pub. No.: US 2024/0008491 A1
(43) Pub. Date: Jan. 11, 2024

(54) PESTICIDE COMPOSITION FOR CONTROLLING WHEAT CROWN ROT AND APPLICATION

(71) Applicant: Institute of Plant Protection and Agro-products Safety, Anhui Academy of Agricultural Sciences, HEFEI (CN)

(72) Inventors: XUEXIANG REN, HEFEI (CN); ZHENDONG TANG, HEFEI (CN); YU CHI, HEFEI (CN); ZHAOBU LIU, HEFEI (CN); ZHAO LI, HEFEI (CN); XIANYAN SU, HEFEI (CN); ZHENGHE YE, HEFEI (CN)

(21) Appl. No.: 18/312,894

(22) Filed: May 5, 2023

(30) Foreign Application Priority Data
Jul. 8, 2022 (CN) 202210805641.9

(51) Int. Cl. A01N 43/653; A01N 43/50; A01P 3/00

(52) U.S. Cl. CPC A01N 43/653; A01N 43/50; A01P 3/00

(57) ABSTRACT

The present invention discloses a pesticide composition for controlling wheat crown rot, comprising prothioconazole and imazalil, and the mass ratio of the prothioconazole to the imazalil is (10-20):1, 1:1 or 1:(10-20). Compared with a single pesticide, the composition of the present invention has an obvious synergistic effect on wheat crown rot, obviously improves the control effect and significantly reduces the pesticide cost; can slow down the resistance of wheat crown rot to the pesticide and prolong the service life of the pesticide; has both quick acting effect and long acting effect on wheat crown rot; can greatly reduce the field application amount and effectively reduce environmental pollution and pesticide residues; and reduces toxicity to other non-target organisms.

### CROSS REFERENCE TO RELATED APPLICATION

The present claims the benefit and priority of Chinese Patent Application No. 202210805641.9 filed on Jul. 8, 2022, the disclosure of which is incorporated by reference herein in its entirety as part of the present application

### TECHNICAL FIELD

The present invention belongs to the technical field of chemical control for diseases, and particularly relates to a pesticide composition for controlling wheat crown rot and application.

### BACKGROUND

Wheat crown rot is one of the diseases that cause white head in wheat in recent years, which mainly occurs in the periods of double-cropping rotation and straw returning of maize and wheat. Wheat crown rot starts to infect at the seedling stage. The pathogen first invades the rhizome through the decaying coleoptile and then spreads upward to the tillering node. The disease mainly affects 1 or 2 leaf sheaths at the basal part of wheat stem. The affected leaf sheaths will turn brown or black brown.

Prothioconazole is a new broad-spectrum triazolthione fungicide developed by Bayer, which is mainly used for controlling many diseases of cereal, wheat and legume crops. Prothioconazole has low toxicity, no teratogenicity, mutagenicity and no toxicity to embryos, and is safe to human and environment. The mechanism of action is to inhibit demethylation of the precursor of sterol in fungi—lanosterol or 2,4-ethylene dihydrolanosterol 14.

Imazalil, also called enilconazole, is a systemic fungicide, which has the characteristics of strong systemic translocation and strong conductivity and is the main pesticide in agricultural production.

So far, no report has been found on the control of wheat crown rot by the pesticide composition of prothioconazole and imazalil. Therefore, how to develop a pesticide composition for controlling wheat crown rot and application is a technical problem to be urgently solved by those skilled in the art.

### SUMMARY

In view of this, the present invention provides a pesticide composition for controlling wheat crown rot and application.

To achieve the above purpose, the present invention adopts the following technical solution:

A pesticide composition for controlling wheat crown rot, comprising prothioconazole and imazalil, wherein the mass ratio of the prothioconazole to the imazalil is (10-20):1, 1:1 or 1:(10-20).

Further, the formulation of the pesticide composition for controlling wheat crown rot is one of emulsifiable concentrate, suspension concentrate, water dispersible granules, wettable powder, emulsion in water, capsule suspension and flowable concentrate for seed coating.

Further, when the formulation of the pesticide composition for controlling wheat crown rot is emulsifiable concentrate, the pesticide composition is prepared from the following raw materials by mass percent: 5%-25% of prothioconazole, 10%-35% of imazalil, 15%-40% of solvent and 5%-25% of emulsifier.

Further, when the formulation of the pesticide composition for controlling wheat crown rot is emulsifiable concentrate, a preparation method for the pesticide composition comprises the following steps: weighing raw materials according to the above mass percent, dissolving prothioconazole and imazalil in solvent, adding emulsifier and stirring well, thus obtaining the emulsifiable concentrate of the pesticide composition.

Further, when the formulation of the pesticide composition for controlling wheat crown rot is wettable powder, the pesticide composition is prepared from the following raw materials by mass percent: 1%-50% of imazalil, 1%-30% of prothioconazole, 3%-10% of dispersant, 1%-8% of wetting agent and the balance of filler.

Further, when the formulation of the pesticide composition for controlling wheat crown rot is wettable powder, a preparation method for the pesticide composition comprises the following steps: weighing raw materials according to the above mass percent, mixing prothioconazole, imazalil, dispersant, wetting agent and filler, stirring well, and mixing uniformly after pulverizing with a jet mill, thus obtaining the wettable powder of the pesticide composition.

Further, when the formulation of the pesticide composition for controlling wheat crown rot is water dispersible granules, the pesticide composition is prepared from the following raw materials by mass percent: 1%-50% of imazalil, 1%-20% of prothioconazole, 2%-8% of dispersant, 2%-8% of wetting agent, 2%-4% of disintegrant and the balance of filler.

Further, when the formulation of the pesticide composition for controlling wheat crown rot is water dispersible granules, a preparation method for the pesticide composition comprises the following steps: weighing raw materials according to the above mass percent, mixing imazalil, prothioconazole, dispersant, wetting agent, disintegrant and filler uniformly, pulverizing with an ultra-micro jet mill, kneading, and then granulating, drying and sieving in a fluidized bed granulating dryer, thus obtaining the water dispersible granules of the pesticide composition.

Further, when the formulation of the pesticide composition for controlling wheat crown rot is suspension concentrate, the pesticide composition is prepared from the following raw materials by mass percent: 1%-40% of imazalil, 1%-30% of prothioconazole, 3%-6% of dispersant, 1%-4% of wetting agent, 0.5%-4% of anti-freezing agent, 0.1%-3% of thickener, 0.1%-1% of antifoamer and the balance of water.

Further, when the formulation of the pesticide composition for controlling wheat crown rot is suspension concentrate, a preparation method for the pesticide composition comprises the following steps: weighing raw materials according to the above mass percent, mixing dispersant, wetting agent, anti-freezing agent, thickener, antifoamer and water, mixing uniformly by high-speed shearing, adding imazalil and prothioconazole, and grinding in a sand mill for 1-4 h to make the particle diameter less than 5 μm, thus obtaining the suspension concentrate of the pesticide composition.

Further, when the formulation of the pesticide composition for controlling wheat crown rot is emulsion in water, the pesticide composition is prepared from the following raw materials by mass percent: 1%-30% of imazalil, 1%-30% of prothioconazole, 2%-6% of emulsifier, 3%-5% of solvent, 1%-3% of anti-freezing agent, 0.1%-5% of thickener, 0.1%-1% of antifoamer and the balance of water.

Further, when the formulation of the pesticide composition for controlling wheat crown rot is emulsion in water, a preparation method for the pesticide composition comprises the following steps: weighing raw materials according to the above mass percent, mixing imazalil, prothioconazole, solvent and emulsifier, and dissolving into homogeneous oil phase; mixing water, anti-freezing agent, thickener and antifoamer into homogeneous aqueous phase; and adding the aqueous phase into the oil phase under high-speed stirring at 3000 rpm, and conducting high-speed shearing for 5-10 min, thus obtaining the emulsion in water of the pesticide composition.

Further, when the formulation of the pesticide composition for controlling wheat crown rot is capsule suspension, the pesticide composition is prepared from the following raw materials by mass percent: 1%-30% of imazalil, 1%-20% of prothioconazole, 0.5%-4% of capsule shell material, 1%-3% of solvent, 1%-4% of dispersant, 2%-4% of emulsifier, 1%-2% of thickener, 0-2% of pH regulator and the balance of water.

Further, when the formulation of the pesticide composition for controlling wheat crown rot is capsule suspension, a preparation method for the pesticide composition comprises the following steps: weighing raw materials according to the above mass percent, (1) dissolving imazalil and prothioconazole in solvent, adding capsule shell material, and stirring well to obtain oil phase; (2) adding emulsifier and PH regulator into water, and stirring well to obtain aqueous phase; (3) adding the aqueous phase into the oil phase, and homogenizing at high speed to form oil-in-water emulsion; (4) at 450-600 rpm, adding polyamine for interfacial polymerization, increasing the reaction temperature to 25-70° C., and keeping for 2-24 h to cure into capsules; and (5) adding dispersant and thickener, and stirring well, thus obtaining the capsule suspension of the pesticide composition.

Further, when the formulation of the pesticide composition for controlling wheat crown rot is flowable concentrate for seed coating, the pesticide composition is prepared from the following raw materials by mass percent: 1%-20% of imazalil, 1%-20% of prothioconazole, 3%-6% of dispersant, 1%-4% of wetting agent, 0.5%-4% of anti-freezing agent, 0.1%-3% of thickener, 0.1%-0.2% of antifoamer, 1%-4% of dye, 1%-5% of film former and the balance of water.

Further, when the formulation of the pesticide composition for controlling wheat crown rot is flowable concentrate for seed coating, a preparation method for the pesticide composition comprises the following steps: weighing raw materials according to the above mass percent, mixing dispersant, wetting agent, anti-freezing agent, thickener, antifoamer and water, mixing uniformly by shearing at 3000 rpm, adding imazalil and prothioconazole, grinding in a sand mill for 1-4 h to make the particle diameter less than 5 μm, and adding film former and dye, thus obtaining the flowable concentrate for seed coating.

Further, the emulsifier is one or more of alkylnaphthalene sulphonate, alkylphenol ethoxylate phosphate, diphenylphenol polyoxyethylene polyoxypropylene ether, styrylphenol polyoxyethylene ether, diphenylphenol polyoxyethylene polyformaldehyde condensate, pesticide emulsifier BY, NNO, NP, pesticide emulsifier 500, pesticide emulsifier 600, Tween-80 and polyvinyl alcohol.

Further, the dispersant is one or more of ligninsulfonate, fatty acid amide N-methyltaurine sodium salt, alkylphenol polyoxyethylene sulfate, polyoxyethylene polyoxypropylene block copolymer, alkylphenol polyoxyethylene and fatty alcohol polyoxyethylene ether.

Further, the wetting agent is one or more of sodium dodecyl sulfate, calcium dodecylbenzene sulfonate, nekal BX, sodium alkylbenzene sulfonate, polyoxyethylene tristyrene phenyl phosphate and saponin powder.

Further, the disintegrant is one or more of bentonite, urea, ammonium sulfate, aluminum chloride, citric acid, succinic acid and sodium bicarbonate.

Further, the filler is one or more of kaolin, diatomite, bentonite, attapulgite, white carbon black, starch and light calcium carbonate.

Further, the thickener is one or more of magnesium aluminum silicate, xanthan gum, methylol cellulose, arabic gum and polyvinyl pyrrolidone.

Further, the anti-freezing agent is one or more of glycol, propylene glycol, glycerin and polyethylene glycol.

Further, the antifoamer is one or more of silicone oil, silicone compound, C10-20 saturated fatty acid compound, C8-10 fatty alcohol compound and polyoxyethylene glyceryl ether.

Further, the capsule shell material is one or more of methylphenyl isocyanate, polyaryl polymethylene isocyanate, methylene diphenyl diisocyanate and urea-formaldehyde resin.

Further, the solvent is one or more of methylbenzene, dimethylbenzene, ethanol, N,N-dimethylformamide, trichloromethane, cyclohexanone, cyclohexane and acetone.

Further, the pH regulator is one of hydrochloric acid, glacial acetic acid, citric acid, sodium hydroxide, aqueous ammonia, ethylenediamine, triethanolamine and triethylamine.

The present invention has the following beneficial effects: (1) compared with a single pesticide, the composition of the present invention has an obvious synergistic effect on wheat crown rot, obviously improves the control effect and significantly reduces the pesticide cost; (2) can slow down the resistance of wheat crown rot to the pesticide and prolong the service life of the pesticide; (3) has both quick acting effect and long acting effect on wheat crown rot; (4) can greatly reduce the field application amount and effectively reduce environmental pollution and pesticide residues; and (5) reduces toxicity to other non-target organisms.

The present invention also provides application of the pesticide composition for controlling wheat crown rot in control of wheat crown rot.

### DETAILED DESCRIPTION

The technical solutions in embodiments of the present invention will be clearly and fully described below. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

### Embodiment 1

A preparation method for the emulsifiable concentrate of the pesticide composition for controlling wheat crown rot comprises the following steps: weighing 2 g of prothioconazole, 20 g of imazalilm, 10 g of ethanol, 7 g of N,N-dimethylformamide and 5 g of pesticide emulsifier 500, dissolving prothioconazole and imazalil in N,N-dimethylformamide, adding pesticide emulsifier 500, and stirring well, thus obtaining the emulsifiable concentrate of the pesticide composition.

### Embodiment 2

A preparation method for the wettable powder of the pesticide composition for controlling wheat crown rot comprises the following steps: weighing 40 g of imazalil, 4 g of prothioconazole, 7 g of fatty acid amide N-methyltaurine sodium salt and 10 g of saponin powder, weighing attapulgite to the total mass of 100 g, mixing prothioconazole, imazalil, fatty acid amide N-methyltaurine sodium salt, saponin powder and attapulgite, stirring well, and mixing uniformly after pulverizing with a jet mill to less than 50 thus obtaining the wettable powder of the pesticide composition.

### Embodiment 3

A preparation method for the water dispersible granules of the pesticide composition for controlling wheat crown rot comprises the following steps: weighing 20 g of imazalil, 2 g of prothioconazole, 6 g of fatty acid amide N-methyltaurine sodium salt, 6 g of sodium alkylbenzene sulfonate, 2 g of NNO and 3 g of urea, weighing attapulgite to the total mass of 100 g, mixing imazalil, prothioconazole, fatty acid amide N-methyltaurine sodium salt, sodium alkylbenzene sulfonate, NNO, urea and attapulgite uniformly, pulverizing with an ultra-micro jet mill to less than 30 kneading, and then granulating, drying to the water content of less than 7% and 200-mesh sieving in a fluidized bed granulating dryer, thus obtaining the water dispersible granules of the pesticide composition.

### Embodiment 4

A preparation method for the suspension concentrate of the pesticide composition for controlling wheat crown rot comprises the following steps: weighing 20 g of imazalil, 2 g of prothioconazole, 4 g of PEG2000, 1.7 g of sodium lignin sulfonate, 0.1 g of 1-octanol, 4 g of glycol, 1.5 g of magnesium aluminum silicate and 1.5 g of xanthan gum according to the above mass percent, weighing water to the total mass of 100 g, mixing PEG2000, sodium lignin sulfonate, 1-octanol, glycol, magnesium aluminum silicate, xanthan gum and water, mixing uniformly by high-speed shearing, adding imazalil and prothioconazole, and grinding in a sand mill for 1 h to make the particle diameter less than 5 μm, thus obtaining the suspension concentrate of the pesticide composition.

### Embodiment 5

A preparation method for the emulsion in water of the pesticide composition for controlling wheat crown rot comprises the following steps: weighing 10 g of imazalil, 1 g of prothioconazole, 4 g of pesticide emulsifier 600, 6 g of N,N-dimethylformamide, 6 g of ethanol, 3 g of magnesium aluminum silicate, 2 g of urea and 0.5 g of polyoxyethylene glyceryl ether according to the above mass percent, weighing water to the total mass of 100 g, mixing imazalil, prothioconazole, N,N-dimethylformamide and PEG400, and dissolving into homogeneous oil phase; mixing water and glycol into homogeneous aqueous phase; and adding the aqueous phase into the oil phase under high-speed stirring at 3000 rpm, and conducting high-speed shearing for 10 min, thus obtaining the emulsion in water of the pesticide composition.

### Embodiment 6

A preparation method for the capsule suspension of the pesticide composition for controlling wheat crown rot comprises the following steps: weighing 5 g of imazalil, 0.5 g of prothioconazole, 5 g of N,N-dimethylformamide, 0.8 g of methylene diphenyl diisocyanate, 2 g of polyvinyl alcohol, 1 g of fatty acid amide N-methyltaurine sodium salt, 1.3 g of hexamethylene diamine, 1 g of potassium dihydrogen phosphate and 0.1 g of xanthan gum, weighing water to the total mass of 100 g, (1) dissolving imazalil and prothioconazole into N,N-dimethylformamide, adding diisocyanate, and stirring well to obtain oil phase; (2) adding pesticide emulsifier 600 and potassium dihydrogen phosphate into water, and stirring well to obtain aqueous phase; (3) adding the aqueous phase into the oil phase, and homogenizing at high speed to form oil-in-water emulsion; (4) at 600 rpm, adding hexamethylene diamine for interfacial polymerization, increasing the reaction temperature to 55° C., and keeping for 6 h to cure into capsules; and (5) adding sodium lignin sulfonate and xanthan gum, and stirring well, thus obtaining the capsule suspension of the pesticide composition.

### Embodiment 7

A preparation method for the flowable concentrate for seed coating of the pesticide composition for controlling wheat crown rot comprises the following steps: weighing 2 g of prothioconazole, 20 g of imazalil, 4 g of PEG4000, 1.7 g of sodium lignin sulfonate, 1.5 g of magnesium aluminum silicate, 0.15 g of xanthan gum, 4 g of glycol, 0.1 g of 1-octanol, 3 g of sodium carboxymethylcellulose and 4 g of dye, weighing water to the total mass of 100 g, mixing PEG4000, sodium lignin sulfonate, magnesium aluminum silicate, xanthan gum, glycol, 1-octanol and water uniformly by shearing at 3000 rpm, adding imazalil and prothioconazole, grinding in a sand mill for 1 h to make the particle diameter less than 5 μm, and adding film former and dye, thus obtaining the flowable concentrate for seed coating.

Effect Experiment

The method of combining indoor toxicity test and field experiment is adopted.

First of all, co-toxicity coefficients of the complex pesticide of different proportions to wheat crown rot are obtained through indoor toxicity test (growth rate method); and then, the control effect is determined through field efficacy test, and the formula proportion and optimal application amount of the complex pesticide are determined.

Field effect: The formula with a synergistic effect obtained from indoor bioassay is prepared into emulsifiable concentrate (EC), suspension concentrate (SC), wettable powder (WP), water dispersible granules (WDG), emulsion in water (EW), capsule suspension (CS) and flowable concentrate for seed coating (FSC) for testing. After the pesticide is sprayed in a community, the control effect is checked, and the appropriate application amount is determined.

Table 1 shows the test results of toxicity of three pesticides and mixture thereof to wheat crown rot.

It can be seen from Table 1 that prothioconazole and imazalil show good indoor toxicity to wheat crown rot, and the co-toxicity coefficients of prothioconazole and imazalil mixed within the range of 20:1-10:1, 1:10-1:20 and 1:1 to wheat crown rot are larger than 120, which shows a good synergistic effect.

TABLE 1
Toxicity of Prothioconazole and Imazalil Mixed in Different Proportions
to Wheat Crown Rot

| | | Co-toxicity |
|---|---|---|
| Pesticide | EC₅₀ (mg/L) | Coefficient (CTC) |
| Prothioconazole (A) | 1.371 | ~ |
| Imazalil (B) | 0.175 | ~ |
| A:B 20:1 | 0.814 | 127.07 |
| A:B 10:1 | 0.664 | 127.35 |
| A:B 5:1 | 0.564 | 113.64 |
| A:B 2:1 | 0.432 | 96.81 |
| A:B 1:1 | 0.247 | 125.66 |
| A:B 1:2 | 0.213 | 115.85 |
| A:B 1:5 | 0.184 | 111.29 |
| A:B 1:10 | 0.152 | 125.05 |
| A:B 1:20 | 0.127 | 143.77 |

The method for controlling wheat crown rot with the above pesticide composition is to spray the suspension of relevant concentration prepared from the pesticide composition and water when 5%-10% of wheat has crown rot or to use seed coating to control crown rot.

The field experiment results are shown in Table 2. The experiment is conducted in Anhui Yingshang Experimental Base.

TABLE 2
Control Effect Experiment on Wheat Crown Rot in Embodiments

| | Application Amount | | |
|---|---|---|---|
| | per Mu/Active | 5 d Control | 15 d Control |
| Pesticide | Component/g | Effect/% | Effect/% |
| Embodiment 1 | 7 | 72.1 | 62.4 |
| Embodiment 2 | 7 | 74.8 | 60.3 |
| Embodiment 3 | 7 | 69.3 | 57.7 |
| Embodiment 4 | 7 | 71.5 | 62.2 |
| Embodiment 5 | 7 | 75.2 | 63.5 |
| Embodiment 6 | 7 | 68.3 | 60.4 |
| Embodiment 7 | 7 | 81.2 | 77.5 |
| 5% | 7 | 67.1 | 41.2 |
| Prothioconazole | | | |
| SC | | | |
| 10% Imazalil SC | 7 | 64.1 | 27.6 |

It can be seen that the embodiments have a control effect on wheat crown rot significantly higher than a control agent and have good quick-acting property and long-acting property, and particularly, the flowable concentrate for seed coating can significantly improve the control effect on wheat crown rot, which is the most effective experiment method to control the disease.

In addition, the formula can also be prepared into ultra-low volume concentrate for aircraft spray as well as hot fogging concentrate, aerosol and other formulations that are easily conceived by those skilled in the art for the control of wheat crown rot.

The description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. A pesticide composition for controlling wheat crown rot, comprising prothioconazole and imazalil, wherein the mass ratio of the prothioconazole to the imazalil is (10-20):1, 1:1 or 1:(10-20).

2. The pesticide composition for controlling wheat crown rot according to claim 1, wherein the formulation of the pesticide composition for controlling wheat crown rot is one of emulsifiable concentrate, suspension concentrate, water dispersible granules, wettable powder, emulsion in water, capsule suspension and flowable concentrate for seed coating.

3. The pesticide composition for controlling wheat crown rot according to claim 2, wherein when the formulation of the pesticide composition for controlling wheat crown rot is emulsifiable concentrate, the pesticide composition is prepared from the following raw materials by mass percent: 5%-25% of prothioconazole, 10%-35% of imazalil, 15%-40% of solvent and 5%-25% of emulsifier.

4. The pesticide composition for controlling wheat crown rot according to claim 2, wherein when the formulation of the pesticide composition for controlling wheat crown rot is wettable powder, the pesticide composition is prepared from the following raw materials by mass percent: 1%-50% of imazalil, 1%-30% of prothioconazole, 3%40% of dispersant, 1%-8% of wetting agent and the balance of filler.

5. The pesticide composition for controlling wheat crown rot according to claim 2, wherein when the formulation of the pesticide composition for controlling wheat crown rot is water dispersible granules, the pesticide composition is prepared from the following raw materials by mass percent: 1%-50% of imazalil, 1%-20% of prothioconazole, 2%-8% of dispersant, 2%-8% of wetting agent, 2%-4% of disintegrant and the balance of filler.

6. The pesticide composition for controlling wheat crown rot according to claim 2, wherein when the formulation of the pesticide composition for controlling wheat crown rot is suspension concentrate, the pesticide composition is prepared from the following raw materials by mass percent: 1%-40% of imazalil, 1%-30% of prothioconazole, 3%-6% of dispersant, 1%-4% of wetting agent, 0.5%-4% of anti-freezing agent, 0.1%-3% of thickener, 0.1%-1% of antifoamer and the balance of water.

7. The pesticide composition for controlling wheat crown rot according to claim 2, wherein when the formulation of the pesticide composition for controlling wheat crown rot is emulsion in water, the pesticide composition is prepared from the following raw materials by mass percent: 1%-30% of imazalil, 1%-30% of prothioconazole, 2%-6% of emulsifier, 3%-5% of solvent, 1%-3% of anti-freezing agent, 0.1%-5% of thickener, 0.1%-1% of antifoamer and the balance of water.

8. The pesticide composition for controlling wheat crown rot according to claim 2, wherein when the formulation of the pesticide composition for controlling wheat crown rot is capsule suspension, the pesticide composition is prepared from the following raw materials by mass percent: 1%-30% of imazalil, 1%-20% of prothioconazole, 0.5%-4% of capsule shell material, 1%-3% of solvent, 1%-4% of dispersant, 2%-4% of emulsifier, 1%-2% of thickener, 0-2% of pH regulator and the balance of water.

9. The pesticide composition for controlling wheat crown rot according to claim 2, wherein when the formulation of the pesticide composition for controlling wheat crown rot is flowable concentrate for seed coating, the pesticide composition is prepared from the following raw materials by mass percent: 1%-20% of imazalil, 1%-20% of prothioconazole, 3%-6% of dispersant, 1%-4% of wetting agent, 0.5%-4% of anti-freezing agent, 0.1%-3% of thickener, of antifoamer, 1%-4% of dye, 1%-5% of film former and the balance of water.

10. Application of the pesticide composition for controlling wheat crown rot of claim 1 in control of wheat crown rot.
